(19) United States
(12) Patent Application Publication
(10) Pub. No.: US 2025/0150368 A1
(43) Pub. Date: May 8, 2025

(54) SYSTEM AND METHOD FOR NETWORK TELEMETRY DATA ANALYSIS WITH STREAM PROCESSING AND NON-UNIFORM SAMPLING

(71) Applicant: Aviz Networks, Inc., San Jose, CA (US)

(72) Inventors: Niloy Mukherjee, San Jose, CA (US); Chidambaram Bhagavathiperumal, Livermore, CA (US); Ashok Kumar Murthy, Chennai (IN)

(73) Assignee: Aviz Networks, Inc., San Jose, CA (US)

(21) Appl. No.: 18/405,199

(22) Filed: Jan. 5, 2024

Related U.S. Application Data
(63) Continuation-in-part of application No. 18/504,991, filed on Nov. 8, 2023.

(51) Int. Cl. H04L 43/067; H04L 41/0604; H04L 43/16

(52) U.S. Cl. CPC H04L 43/067; H04L 41/0627; H04L 43/16

(57) ABSTRACT

In some implementations, the method may include providing one or more collectors which periodically request memory utilization from a device. In addition, the method may include receiving, by a stream processor, memory utilization from the one or more collectors. The method may include monitoring, by the stream processor, if an average memory utilization evaluated over a predetermined time crosses a predetermined threshold (for example 5 minutes). Moreover, the method may include sending data downstream to a data sink for persistence. Also, the method may include sending a new sampling strategy to the one or more collectors, if the average memory utilization evaluated over the predetermined time crosses the predetermined threshold.

### CROSS REFERENCE TO RELATED APPLICATIONS

The present application is a continuation of U.S. patent application Ser. No. 18/504,991, filed Nov. 8, 2023, the disclosure of which is entirely incorporated by reference herein.

### BACKGROUND

Networks generate massive amounts of data in real time. Analyzing this data offline or in batch mode can introduce significant latency, making it difficult to detect and respond to issues in real time.

Conventional uniform sampling techniques used for data collection have additional limitations. These techniques might miss unusual events occurring during non-sampled intervals. Analyzing massive real-time data offline introduces latency, impacting the timely detection and response to network issues.

A common method for collecting network telemetry data is uniform sampling where data is collected at a predefined interval. Although this method is easy to implement, it has several limitations. For example, unusual events could be missed if they occur during non-sampled intervals. Additionally, determining an appropriate sampling rate can be challenging. A rate that's too high leads to resource exhaustion, while a rate that's too low will miss important events. Furthermore, such an approach may include an oversampling of normal behavior and an undersampling of important events. What is needed are improved methods of analysis and collection of network telemetry data in real-time.

The present disclosure effectively addresses the limitations provided above.

### SUMMARY

The present disclosure provides systems and methods that integrate non-uniform sampling with stream processing. According to embodiments disclosed herein, non-uniform sampling selectively collects data based on network conditions, providing benefits like focusing on crucial network areas and efficient resource allocation. This unique approach allows for adaptive data collection, in-depth analysis, real-time alerting, and automated responses.

This analysis and collection of network telemetry data in real-time is crucial for maintaining the health, performance, security and troubleshooting networks, and providing insights into the real-time and historical behavior of the network devices, connections, and traffic. The present disclosure further provides a generative AI architecture that leverages the power of Large Language Models (LLMs) and the scalable infrastructure of the cloud native ecosystem to effectively process, analyze, and derive insights from network telemetry data. Embodiments of the present disclosure provide for systems and methods of network telemetry data analysis and stream processing. The embodiments disclosed herein provide processes that increase the efficiency of a cloud native ecosystem to effectively process, analyze, and derive insights from network telemetry data.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, according to an embodiment the method may include providing one or more collectors which periodically request memory utilization from a device. The method may also include receiving, by a stream processor, memory utilization from the one or more collectors. The method may furthermore include monitoring, by the stream processor, if an average memory utilization evaluated over a predetermined time crosses a predetermined threshold. In an alternative embodiment, the threshold may be adjusted in real time. The method may in addition include sending data downstream to a data sink for persistence. The method may moreover include sending a new sampling strategy to collector(s), if the average memory utilization evaluated over the predetermined time crosses the predetermined threshold. Specific embodiments disclosed herein disclose the predetermined time and predetermined threshold. Other embodiments of this aspect include corresponding computer systems, apparatus, and computer programs recorded on one or more computer storage devices, each configured to perform the actions of the methods.

Implementations may include one or more of the following features. The method may include requesting, by the one or more collectors, process information repeatedly from the device for a predetermined process information period of time; and receiving, by the stream processor, process information repeatedly at a predetermined process information frequency from the one or more collectors. The method may include generating alerts, by the stream processor, and sending the generated alerts to the data sink. The method may include periodically requesting memory utilization from the device, by the collector(s), approximately every 30 seconds and sending the memory utilization to the stream processor. Implementations of the described techniques may include hardware, a method or process, or a computer tangible medium.

### BRIEF DESCRIPTION OF THE DRAWINGS

Certain features may be illustrated as examples in the accompanying drawings and should not be considered as limitations. In these drawings, identical numbers indicate corresponding elements.

FIG. 1 illustrates a network environment of a network state data processing platform according to an embodiment of the present disclosure.

FIG. 2 is an implementation of a process architecture according to an embodiment of the present disclosure.

FIG. 3 is a flowchart of a process of creating a generative AI framework on network state telemetry.

FIG. 4 discloses a response from the Agent.

FIG. 5 is a flowchart of an example process according to an embodiment of the present disclosure.

FIG. 6 illustrates a pipeline with the stream processor positioned between the collector and the data sink according to an embodiment of the present disclosure.

FIG. 7 shows a data flow architecture between the components in the pipeline using non-uniform sampling based on the real time analysis of telemetry data by the stream processor.

FIG. 8 illustrates an example process of real-time analysis of telemetry data by a stream processor.

### DETAILED DESCRIPTION

The following descriptions of various embodiments refer to the accompanying drawings identified above. These drawings depict ways to implement the aspects described. However, other embodiments can be employed, and modifications in structure and function are permissible without veering away from the scope outlined in this document. The terminology and phrasing used in this document are meant for descriptive purposes and should not be seen as restrictive. Instead, every term is intended to be interpreted in its broadest sense and connotation. Words like “including” and “comprising,” along with their derivatives, are meant to cover not only the listed items but also their equivalents and additional items, expanding their scope and inclusivity.

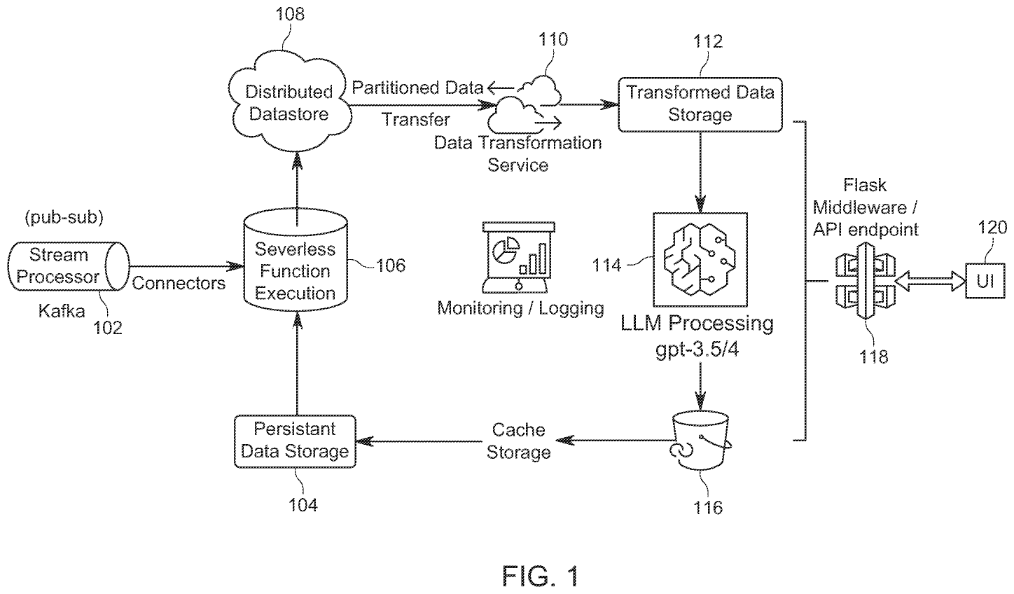

By way of example, FIG. 1 illustrates a network environment 100 of a network state data processing platform according to an embodiment of the present disclosure. Stream producer 102 is responsible for the generation and transmission of data to a designated stream or topic within the stream processing system. This data, which may take the form of events, messages, or records, is crucial for downstream applications' real-time processing and analysis.

Additionally, stream producer 102 is initiated for handling acknowledgments, enabling reliable message delivery, and can be equipped to manage various error scenarios that may arise during data transmissions. Stream producer 102 can efficiently manage high volumes of data and distribute it to multiple consumers.

According to an embodiment, producers specify the target partition for each message, thereby ensuring even distribution and parallelism. Additionally, the stream producer can address serialization requirements to efficiently encode data for storage and transmission. According to an embodiment, stream producer 102 continuously ingests, processes, and analyzes data in real-time, ensuring efficient handling of large volumes of streaming data. As data flows through the stream processor, it can be enriched and transformed before being forwarded to a serverless function 104.

Next, by utilizing event-driven architecture, serverless function 104 is triggered upon receiving data from the stream producer 102. This ensures optimal resource utilization as the function executes only when needed, scaling automatically to accommodate varying data volumes. Serverless function 104 is equipped with pre-defined logic to further process and format the data, preparing it for storage. It can be appreciated that the serverless function is configured to be executed in response to predefined triggers, without the need for provisioning or managing servers. When a trigger occurs, the serverless event-driven compute dynamically allocates the necessary resources and executes the function.

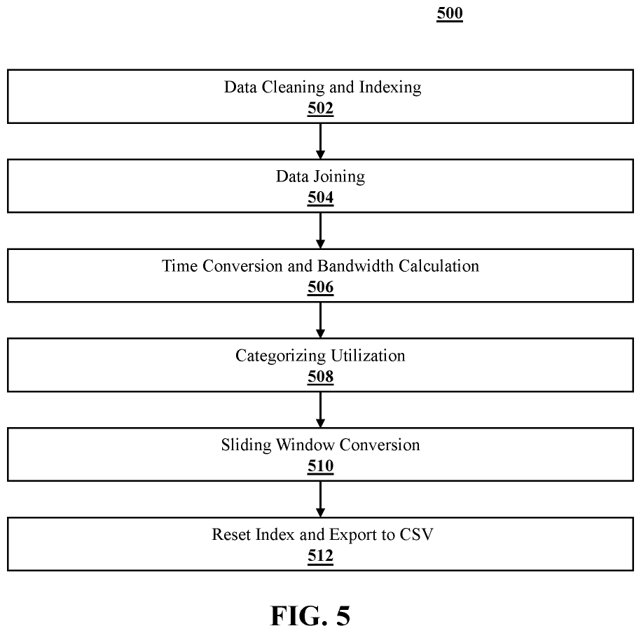

Upon execution completion, the processed data can be seamlessly written to a distributed data store 106. Distributed data store 106 can be a scalable object storage service such as Amazon S3, or another service with high availability, fault tolerance, and scalability, ensures that data is securely stored, easily retrievable, and ready for subsequent analysis and processing. This integration of stream processor, serverless function, and distributed data store creates a robust, efficient, and scalable data processing pipeline to implement the novel processes described herein. Next, a series of transformational steps occurs, as discussed in detail below regarding FIG. 5.

According to an embodiment, in a series of steps, the telemetry data is first cleaned by removing any NaN values. Next, specific indices are set for both telemetry and inventory data. These indices are essential for subsequent joining operations. By setting appropriate indices, telemetry and inventory data are joined in a manner which provides a more comprehensive dataset that includes both dynamic telemetry data and static inventory details. According to a further embodiment, the ‘hash’ attributes is dropped. Other unnecessary attributes may also be dropped at this stage.

According to an embodiment, a ‘starttime’ attribute is converted from a numerical representation to a human-readable timestamp. Next, bandwidth utilization is computed based on the ‘sum’ and ‘count’ attributes. According to an embodiment, this calculation represents the average bandwidth utilization in Mbps, normalized by the ‘totalmaxspeed’.

Next, a categorization of bandwidth utilization is performed. In one embodiment, utilization levels are divided into three categories: ‘well utilized’, ‘moderately utilized’, and ‘under-utilized’. This categorization can provide a higher-level insight into how effectively the network resources are being used.

According to an embodiment, the ‘slidingwindowsize’ attribute is transformed into an understandable format, representing the window size in hours or minutes. This conversion allows for better understanding and potential further time-series analysis.

Next, the processed data is reset to a default index and can be exported to CSV format. CSV is a widely accepted and easily readable data format that can be readily consumed by various tools and platforms. The processed data is subsequently stored in a dedicated repository referred to transformed data storage 112. This data is then primed for further processing through an LLM (Large Language Model) processing unit 114. According to an embodiment, processed data is also cached in “cache storage 118” for expedited access.

To facilitate user interaction and access to this data, a user interface labeled as “user interface 120” is provided. This interface seamlessly connects with a Flask middleware or an API endpoint 118.” This middleware/API endpoint serves as a gateway, enabling users to retrieve results from the cache, as elaborated upon below.

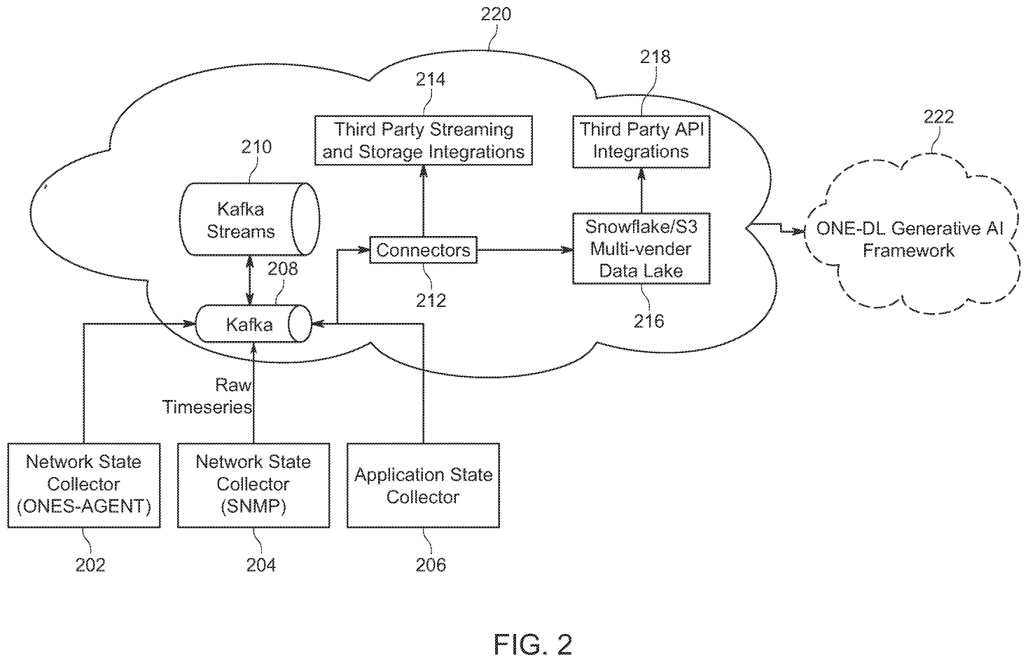

By way of example, FIG. 2 discloses a process architecture implemented in accordance with an embodiment of the current disclosure. Here, the stream producer 208, specifically an Apache Kafka instance, is initiated to serve as the primary channel for the intake of real-time data concerning network and application state telemetry. This data is sourced primarily from a set of network state collectors, namely ONES-AGENT (collector 202) and SNMP (collector 204), in addition to an application state collector 206. This setup ensures efficient and centralized data aggregation from these varied sources. In this configuration, the collectors 212 are initiated to acquire metrics and logs and to offer insights into system operational status. Kafka element 208 is responsible the facilitation of data flow through pre-defined connectors and Streams, thus enabling an array of data manipulations, including filtering, transformation, and enrichment.

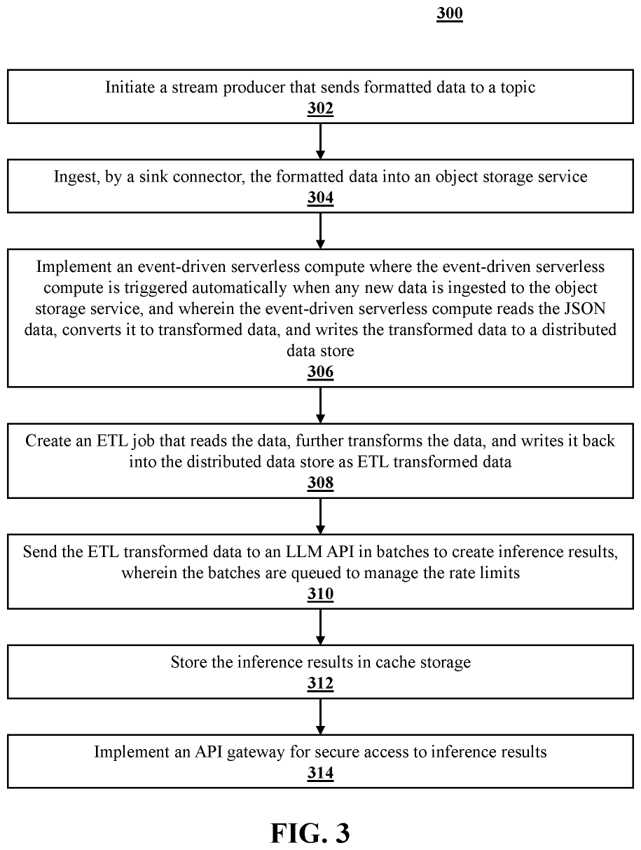

Streams 210 are tasked with real-time data processing, designed to handle data transformation requirements. The ecosystem seamlessly interfaces with external systems, enabling the real time flow of processed data to specialized analytics, reporting, and machine learning tools, as described in FIGS. 3-5.

In this defined architecture, connectors 212 are configured to ensure data is rendered into precise formats and structures, optimized for downstream processing and analyses. One or more connectors 212 acts as a bridge between the stream producer 208 and the data Snowflake or S3 Multi-vendor data lake 216, ensuring that data is reliably and efficiently transmitted from the source to the destination. This can include using a sink connector as a bridge between stream producer 208 and multi-vendor data lake 216.

In one embodiment, data lake 206 comprises a cloud-agnostic database system, originating from both on-premises and cloud sources, wherein it organizes and stores data in tabular formats that are readily consumed by observability applications. AI/ML applications can directly access this data, enabling them to derive intricate patterns and insights, which are instrumental for tasks like alert generation, predictive analytics, forecasting, and automated troubleshooting.

According to an embodiment, data ingestion is handled by a publish-subscribe messaging system, which consumes the bandwidth telemetry data published to a Kafka topic at the producer level. The data can then be encapsulated as JSON arrays and be published in real time. This type of architecture offers a robust and scalable platform for real-time data streaming, enabling the smooth ingestion of large data volumes.

By way of example, FIG. 3 is a flowchart of a process 300 of creating a generative AI framework on network state telemetry. As shown in FIG. 3, process 300 may include initiating a stream producer that sends formatted data to a topic (block 302). For instance, the stream producer might be Apache Pulsar, Amazon Kinesis, or Apache Kafka, sending formatted data to a topic, as previously explained. Using a stream producer offers several including the efficient and continuous transmission of data, and scalability by allowing network systems to handle growing data volumes by distributing the load across multiple servers or clusters. According to an embodiment, Publish/Subscribe (pub sub) Consumers are utilized consume the bandwidth telemetry data published to a Kafka topic at the producer level. According to an embodiment ingested data is encapsulated as JSON arrays and is published in real time. It can be appreciated that this type of data ingestion offers a robust and scalable platform for real-time data streaming, enabling the smooth ingestion of large data volumes.

Utilizing sink connector object store, the ingested data is then transferred to Amazon S3. This sink connector acts as a bridge between the Consumers and the object storage, ensuring that data is reliably and efficiently transmitted from the source to the destination. The integration between pub sub and object store provides data integrity without significant loss of information.

As also shown in FIG. 3, process 300 may include ingesting, by a sink connector, the formatted data into an object storage service (block 304). Such an integration between pub sub and object store data provides integrity without significant loss of information. Object storage can be implemented through Amazon S3, as well as alternative solutions like Google Cloud Storage, Microsoft Azure Blob Storage, and IBM Cloud Object Storage. For example, the device may ingest, by a Pub Sub native object store sink connector, the formatted data into Amazon S3, as described above. According to an embodiment, S3 serves as the sink for the data consumed by Kafka, where it is stored in a structured and organized manner as and when the data is written to the s3 bucket in batches.

As further shown in FIG. 3, process 300 may include processing and transformation steps by implementing an event-driven serverless compute configured to be triggered automatically when any new data is ingested to the object storage service (block 306). According to an embodiment, the event-driven serverless compute reads the data in its native format, converts it to transformed data, and writes the transformed data to a distributed data store. According to an embodiment of the disclosure, the method may implement an event-driven serverless compute by implementing an AWS Lambda function, where the event-driven serverless compute is triggered automatically when any new data is ingested to the object storage service, and where the event-driven serverless compute reads the JSON data, converts it to transformed data, where transformed data is in the CSV format (CSV transformed data), and writes the CSV transformed data to a distributed data store, as described above.

It can be appreciated that utilizing a serverless architecture as described herein eliminates the need for manual intervention, thus enabling seamless and efficient execution of code in reaction to the stream producer. Other embodiments may implement an event-driver serverless compute by using Google Cloud Functions, Microsoft Azure Functions, and IBM Cloud Functions, among others. The processing and transformation phase is a crucial step in preparing the raw data for modeling. This phase includes operations such as data cleaning, transformation, joining, and computation. Such an architecture allows for scalable execution and separation of concerns, where a dedicated machine learning service focuses only on training.

Once preprocessing and transformation are completed, the prepared data is written back to object storage. Storing the transformed data in object storage ensures that it is accessible to other components of the pipeline, such as SageMaker for training and inference. As also shown in FIG. 3, process 300 may include creating an ETL job, where the ETL job reads the data, further transforms the data, and writes it back into the distributed data store as ETL transformed data (block 308). For example, a device may create a glue job, where the glue job reads the data, further transforms the data, and writes it back into the distributed data store as ETL transformed data, as described above. As further shown in FIG. 3, process 300 may include sending the ETL transformed data to an LLM API in batches to create inference results, where the batches are queued to manage the rate limits (block 310).

According to an embodiment, the transformed data is used for training the model and inference tasks are on demand. When the user asks a question in the UI, only then does the system send to the LLM API for inference and generate the response for the question.

Model training is an important part of the data pipeline that leverages the preprocessing and transformation stages to prepare and optimize the model for inference. According to an embodiment, model training encompasses two significant phases: the utilization of generative AI capabilities to pandas (by using a tool such as PandasAI), and data analysis and manipulation by, for example, LangChain for domain-specific applications. The training process has been designed to be incremental and decoupled from the inference, providing scalability and adaptability.

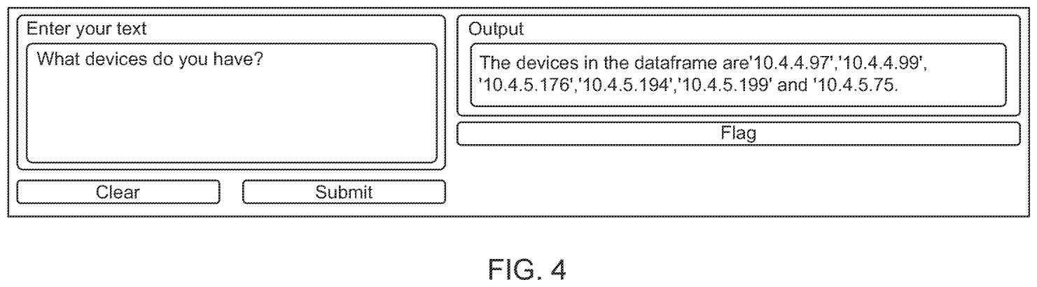

The LangChain platform can be utilized to execute the method's specific steps for domain-specific applications. This step includes a main model training process. In one embodiment, Dask is utilized to handle the parallelization of reading data, which can be of a considerable size, ranging into gigabytes or terabytes, ensuring both speed and efficiency. The data is then compiled into a unified pandas DataFrame, prepared for interaction with the LangChain's Pandas Dataframe agent. Utilizing such a modular architecture facilitates customization, allowing the creation of an agent that can engage with the data in English, as shown in FIG. 4. It transforms natural language queries into pandas commands, delivering human-like responses. According to an embodiment, training data is loaded into the agent.

By separating the training and inference processes in the methods described herein, the system gains flexibility. This separation means that changes or improvements to the training process can be made without affecting the existing inference functionality. It also facilitates parallel development and testing. The architecture supports scalability, allowing for the handling of ever-increasing data sizes and complexity. The system can grow with the needs of the organization without significant re-engineering.

For example, the process may include sending the ETL transformed data to an LLM API in batches to create inference results, where the batches are queued to manage the rate limits, as described above. As also shown in FIG. 3, process 300 may include storing the inference results in cache storage (block 312). Caching plays a crucial role in enhancing data retrieval processes, significantly improving application performance. By storing frequently accessed data in memory, which is much faster than traditional disk storage, applications can retrieve data at accelerated speeds, ensuring a smooth and responsive user experience. This capability is particularly beneficial during high-traffic periods, as cache supports stable performance and prevents slowdowns. Furthermore, by reducing the need for redundant API calls to the LLM, caching not only optimizes speed but also contributes to cost efficiency.

In addition to augmenting speed and cost-effectiveness, caching alleviates the workload on backend databases. This is achieved by reducing the number of direct data requests, minimizing the risk of database slowdowns or crashes during peak usage times. Caching in this manner is particularly advantageous for popular data profiles or items, preventing the overexertion of database resources. With the capacity to handle a multitude of data actions simultaneously, a well-implemented cache system ensures consistent, reliable performance, enhancing the overall efficiency and responsiveness of applications.

Once the training data has been loaded into the Agent, it is ready to be deployed. According to an embodiment, an Amazon Sagemaker Notebook Instance is used to deploy the endpoint. The user query is routed to the API endpoint to be run on the Agent. The generated response is then returned to the user.

It can be appreciated that by using such an approach, the model displays a commendable precision in its response generation. The model proficiently delivers precise answers for queries related to general knowledge. The model has successfully addressed prior challenges like extended training durations and delivering partial or erroneous responses.

As further shown in FIG. 3, process 300 may include implementing an API gateway for secure access to inference results (block 314). For example, the process may implement an API gateway for secure access to inference results, as described above. Process 300 may include additional implementations, such as any single implementation or any combination of implementations described below and/or in connection with one or more other processes described elsewhere herein. In a first implementation, the ETL is triggered whenever the transformed data is added to the distributed data store. In one embodiment, transformed data comprises a file in CSV file format.

In a second implementation, alone or in combination with the first implementation, the distributed data store further may include a cloud storage container.

In a third implementation, alone or in combination with the first and second implementation, the object storage service further may include a multi-vendor data lake.

In a fourth implementation, alone or in combination with one or more of the first through third implementations, cache storage is used for repeated calls to the API gateway.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

FIG. 4 discloses a response from the Agent. According to an embodiment of the present disclosure, to mitigate the recurring need to access the complete dataset, a double buffering method is employed. This approach entails maintaining two files for an API endpoint, though only one remains active at any given time. Given the periodic receival of fresh data, one file operates using the preceding data. Concurrently, the updated dataset—comprising both old and new data—is processed in the second file. While the Agent prepares to accommodate the new data, incoming queries are directed to the initial file. Once the Agent has assimilated the new data, query routing is switched to the second file. The previously secondary file now operates on the new dataset, and the cycle continues. This mechanism efficiently sidesteps the issue of constant large-scale data retrieval.

FIG. 5 is a flowchart of an example process 500. In some implementations, one or more process blocks of FIG. 5 may be performed by a device.

As shown in FIG. 5, process 500 may include Data cleaning and Indexing (block 502). For example, telemetry data is cleaned by removing any NaN values, and specific indices are set for both telemetry and inventory data. These indices are essential for subsequent joining operations, as described above. As also shown in FIG. 5, process 500 may include Data Joining (block 504). By setting appropriate indices, telemetry and inventory data are joined seamlessly. This joining provides a more comprehensive dataset that includes both dynamic telemetry data and static inventory details. Unnecessary attributes like ‘hash’ are also dropped.

As further shown in FIG. 5, process 500 may include Time Conversion and Bandwidth Calculation (block 506). For example, the ‘starttime’ is converted from a numerical representation to a human-readable timestamp. The bandwidth utilization is computed based on the ‘sum’ and ‘count’ attributes. This calculation represents the average bandwidth utilization in Mbps, normalized by the ‘totalmaxspeed’. As also shown in FIG. 5, process 500 may include Categorizing Utilization (block 508). According to an embodiment, a categorization of bandwidth utilization is performed. Utilization levels are divided into three categories: ‘well utilized’, ‘moderately utilized’, and ‘under-utilized’. This categorization provides a higher-level insight into how effectively the network resources are being used. As illustrated in FIG. 5, process 500 further encompasses the steps of resetting the Index and exporting to a CSV file (see block 512). In this phase, the processed data is reverted to a standard index and then exported in CSV format. For instance, the method may perform the index reset and CSV export immediately after categorizing utilization, as previously outlined.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. What has been described and illustrated herein is an example along with some of its variations. The terms, descriptions and figures used herein are set forth by way of illustration only and are not meant as limitations.

The integration of non-uniform sampling with stream processing allows for the selective capture of crucial data points. It can be appreciated that this method ensures that unusual events are not missed, and resource allocation is optimized. Non-uniform sampling or selective sampling is about picking and choosing data points based on certain network conditions, instead of just collecting data evenly from all over. This approach offers several advantages, as described below.

According to an embodiment, a system administrator can adjust how often the system collects data depending on what's happening. If something special is going on or the network is different, the system administrator can collect more or less data to match.

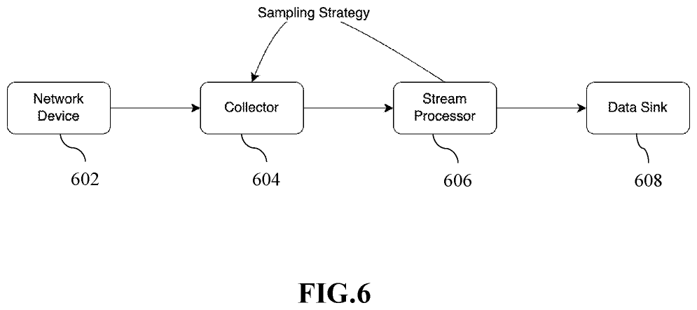

Such an approach allows for achieving meaningful insights and swift issue resolution by processing and analyzing data as it's generated, rather than waiting for batch processing. That is, unlike traditional batch processing that deals with stored data, stream processing tackles data in motion by placing the stream processor between the collector and data sink. FIG. 6 illustrates the pipeline with the stream processor 606 strategically positioned between the collector 604 and the data sink 608.

FIG. 6 discloses a system architecture where a network device 602 provides data to a collector 604, according to an embodiment of the present disclosure. Stream processor 606 then provides a sampling strategy back to collector 604 and sends alerts and other data to data sink 608. According to an embodiment, sampling rates are dynamically adjusted based on the evolving network conditions solving the problem of identifying fixed sampling rates for different metrics. Such an integration with stream processing improves the analysis process by enabling real-time data processing and decision-making. This enables real-time visibility of the network state ensuring that critical events and anomalies are detected and handled.

According to an embodiment, stream processor 606 maintains real-time awareness of the current network state by continuously monitoring the entirety of data passing through it. This inherent capability positions the stream processor as the optimal place for making informed decisions regarding sampling strategies and algorithms. Given its constant engagement with network data, the stream processor empowers us to establish criteria for selective data collection, enact adaptive sampling techniques that dynamically adjust the sampling rate in response to evolving network conditions, subject chosen data points to in-depth analysis while allowing other data points to undergo minimal processing, and enable real-time alerting and automated response strategies.

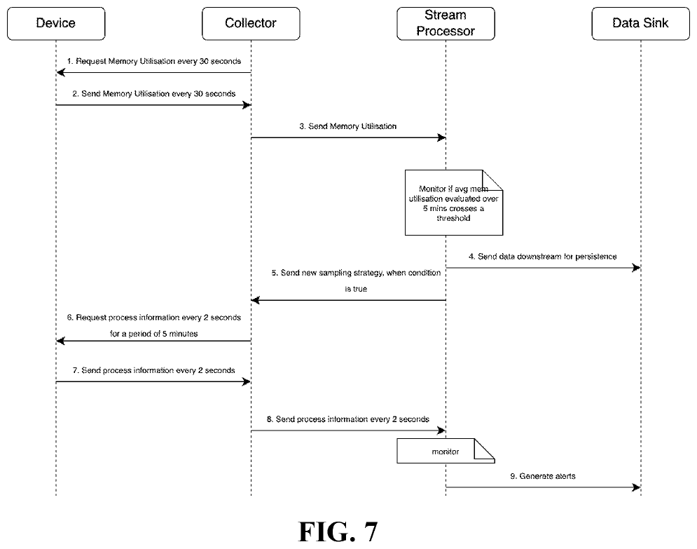

FIG. 7 shows a data flow architecture between the components in the pipeline using non-uniform sampling based on the real time analysis of telemetry data by the stream processor. A collector requests memory utilization from a device, which sends memory utilization every 30 seconds. The collector then sends the memory utilization to a stream processor, which monitors if an average memory utilization evaluated for over 5 minutes crosses a threshold. The stream processor then sends data downstream to a data sink for persistence and sends a new sampling strategy to the collector if the monitoring condition is true. The collector then requests process information from the device every 2 seconds for a period of 5 minutes, and the device sends process information back to the collector every 2 seconds for a period of 5 minutes. The collector then sends process information to the stream processor, which continues to monitor and generate alerts to the data sink.

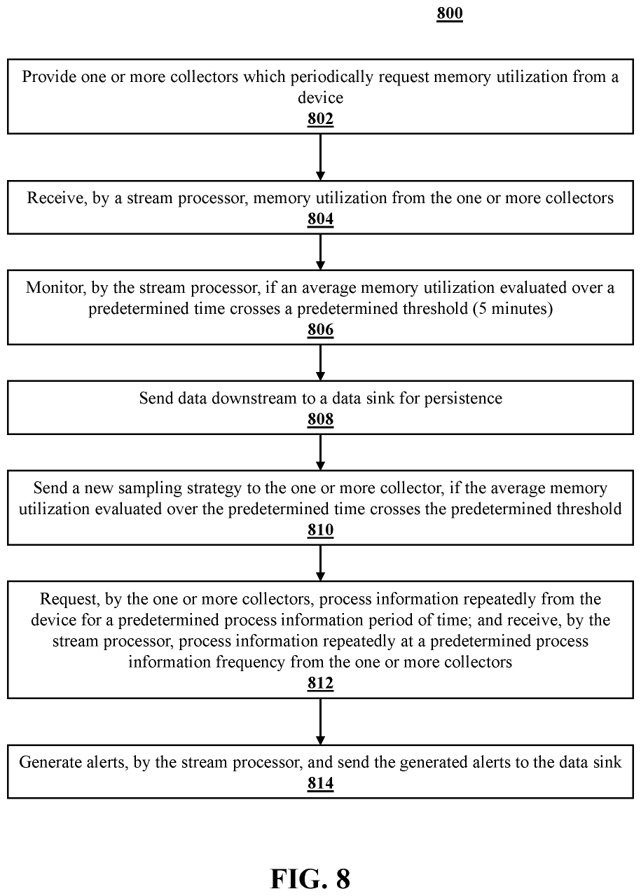

FIG. 8 illustrates an example process of real-time analysis of telemetry data by a stream processor.

As shown in FIG. 8, process 800 may include providing one or more collectors which periodically request memory utilization from a device or multiple devices (block 802). The collectors are capable of requesting memory utilization data from a diverse array of devices, each fulfilling a unique role within the network. This includes servers, which host applications and services, routers and switches that manage data flow, and firewalls that ensure network security. Devices may also include Internet of Things (IoT) devices like smart sensors, as well as virtual machines in virtualized environments. This comprehensive data collection is vital.

For example, the collector may request memory utilization every 30 seconds from a server device, where the server device sends the memory utilization every 30 seconds to the collector. As also shown in FIG. 8, process 800 may include receiving, by a stream processor, memory utilization from the one or more collectors (block 804).

According to one or more embodiments, stream processors may further comprise Apache Kafka Streams, which is a client library for building applications with Kafka, Apache Flink, an open-source framework known for its high performance in processing unbounded and bounded data sets, or Google Cloud Dataflow, a fully managed service, optimizes for both stream and batch processing within the Google Cloud Platform.

As further shown in FIG. 8, process 800 may include monitoring, by the stream processor, if an average memory utilization evaluated over a predetermined time crosses a predetermined threshold (block 806). For example, if an average memory utilization evaluated over 5 minutes crosses a predetermined threshold, as described above. Next, process 800 may include sending data downstream to a data sink for persistence (block 808). For example, an application using Kafka Streams can process data in real-time and then send the processed data to a Kafka topic. From there, it can be consumed by a Kafka Connect sink connector, which can persist the data to various data sinks such as a SQL database, a NoSQL database like MongoDB, or a data warehouse solution like Amazon Redshift. Process 800 may also include sending a new sampling strategy to the one or more collectors, if the average memory utilization evaluated over the predetermined time crosses the predetermined threshold (block 810). For example, the stream processor may send a new sampling strategy to the one or more collectors, if the average memory utilization evaluated over 5 minutes crosses the predetermined threshold, as described above.

Process 800 may include additional implementations, such as any single implementation or any combination of implementations described below and/or in connection with one or more other processes described elsewhere herein. A first implementation, process 800 may include requesting, by the one or more collectors, process information repeatedly from the device for a predetermined process information period of time; and receiving, by the stream processor, process information repeatedly at a predetermined process information frequency from the one or more collectors. In one embodiment, the one or more collectors request process information from the device every 2 seconds for a period of 5 minutes, and the device sends process information to the collectors every 2 seconds for a period of 5 minutes.

A second implementation, alone or in combination with the first implementation, process 800 may include generating alerts, by the stream processor, and sending the generated alerts to the data sink. In an embodiment, the stream processor continuously monitors process information.

A third implementation, alone or in combination with the first and second implementation, process 800 may include periodically requesting memory utilization from the device, by the one or more collectors, approximately every 30 seconds and sending the memory utilization to the stream processor.

In a fourth implementation, alone or in combination with one or more of the first through third implementations, the predetermined time is 5 minutes.

In a fifth implementation, alone or in combination with one or more of the first through fourth implementations, the predetermined process information period of time is approximately 5 minutes, and the predetermined process information frequency is approximately 2 seconds.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

While the detailed description above has presented novel features in relation to various embodiments, it is important to acknowledge that there is room for flexibility, including omissions, substitutions, and modifications in the design and specifics of the devices or algorithms illustrated, all while remaining consistent with the essence of this disclosure. It should be noted that certain embodiments discussed herein can be manifested in various configurations, some of which may not encompass all the features and advantages expounded in this description, as certain features can be implemented independently of others. The scope of the embodiments disclosed here is defined by the appended claims, rather than the preceding exposition. All alterations falling within the meaning and range of equivalence of the claims are to be encompassed within their ambit.

1. A method, comprising:
providing one or more collectors which periodically request memory utilization from a device;
receiving, by a stream processor, memory utilization from the one or more collectors;
monitoring, by the stream processor, if an average memory utilization evaluated over a predetermined time crosses a predetermined threshold (5 minutes);
sending data downstream to a data sink for persistence;
sending a new sampling strategy to the one or more collector, if the average memory utilization evaluated over the predetermined time crosses the predetermined threshold;

2. The method of claim 1, further comprising requesting, by the one or more collectors, process information repeatedly from the device for a predetermined process information period of time; and receiving, by the stream processor, process information repeatedly at a predetermined process information frequency from the one or more collectors

3. The method of claim 2, further comprising generating alerts, by the stream processor, and sending the generated alerts to the data sink.

4. The method of claim 3, further comprising periodically requesting memory utilization from the device, by the one or more collectors, approximately every 30 seconds and sending the memory utilization to the stream processor.

5. The method of claim 3, wherein the predetermined time is 5 minutes.

6. The method of claim 5, wherein the predetermined process information period of time is approximately 5 minutes, and the predetermined process information frequency is approximately 2 seconds.

7. A non-transitory computer-readable medium storing a set of instructions, the set of instructions comprising:
one or more instructions that, when executed by one or more processors of a device, cause the device to:
provide one or more collectors which periodically request memory utilization from a device;
receive, by a stream processor, memory utilization from the one or more collectors;
monitor, by the stream processor, if an average memory utilization evaluated over a predetermined time crosses a predetermined threshold (5 minutes);
send data downstream to a data sink for persistence;
send a new sampling strategy to the one or more collector, if the average memory utilization evaluated over the predetermined time crosses the predetermined threshold.

8. The non-transitory computer-readable medium of claim 7, wherein the one or more instructions further cause the device to:
further comprise requesting, by the one or more collectors, process information repeatedly from the device for a predetermined process information period of time; and
receive, by the stream processor, process information repeatedly at a predetermined process information frequency from the one or more collectors.

9. The non-transitory computer-readable medium of claim 8, wherein the one or more instructions further cause the device to:
generate alerts, by the stream processor, and sending the generated alerts to the data sink.

10. The non-transitory computer-readable medium of claim 9, wherein the one or more instructions further cause the device to:
further comprise periodically requesting memory utilization from the device, by the one or more collectors, approximately every 30 seconds and sending the memory utilization to the stream processor.

11. The non-transitory computer-readable medium of claim 9, wherein the predetermined time is 5 minutes.

12. The non-transitory computer-readable medium of claim 11, wherein the predetermined process information period of time is approximately 5 minutes, and the predetermined process information frequency is approximately 2 seconds.

13. A system comprising:
one or more processors configured to:
provide one or more collectors which periodically request memory utilization from a device;
receive, by a stream processor, memory utilization from the one or more collectors;
monitor, by the stream processor, if an average memory utilization evaluated over a predetermined time crosses a predetermined threshold (5 minutes);
send data downstream to a data sink for persistence;
send a new sampling strategy to the one or more collector, if the average memory utilization evaluated over the predetermined time crosses the predetermined threshold.

14. The system of claim 13, wherein the one or more processors are further configured to:
further comprise requesting, by the one or more collectors, process information repeatedly from the device for a predetermined process information period of time; and
receive, by the stream processor, process information repeatedly at a predetermined process information frequency from the one or more collectors.

15. The system of claim 14, wherein the one or more processors are further configured to:
generate alerts, by the stream processor, and sending the generated alerts to the data sink.

16. The system of claim 15, wherein the one or more processors are further configured to:
further comprise periodically requesting memory utilization from the device, by the one or more collectors, approximately every 30 seconds and sending the memory utilization to the stream processor.

17. The system of claim 15, wherein the predetermined time is 5 minutes.

18. The system of claim 17, wherein the predetermined process information period of time is approximately 5 minutes, and the predetermined process information frequency is approximately 2 seconds.
